(19) United States
(12) Patent Application Publication
(10) Pub. No.: US 2010/0118427 A1
(43) Pub. Date: May 13, 2010

(54) ELIMINATING SECTOR SYNCHRONIZATION FIELDS FOR BIT PATTERNED MEDIA

(76) Inventors: Bruce Douglas Buch, Westborough, MA (US); Mathew P. Vea, Shrewsbury, MA (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(21) Appl. No.: 12/267,215

(22) Filed: Nov. 7, 2008

(51) Int. Cl. G11B 5/09

(52) U.S. Cl. 360/51; G9B/5.033

(57) ABSTRACT

Clock synchronization techniques are described for data storage media, particularly for the tolerances of efficient use of bit patterned media (BPM) capacity. In particular, techniques are described where position of a read-write head and timing of a write and/or read clock is determined within a fraction of a dot of the underlying media. The techniques obviate the requirement for the fields conventionally written preceding a data sector to provide bit synchronization and symbol framing (sector synchronization fields).

### CROSS REFERENCE TO RELATED APPLICATIONS

The present application is related to the following commonly-owned, copending U.S. patent applications, the content of each of which are incorporated herein by reference:

U.S. Publication No. US2008/0080082, published Apr. 3, 2008, by Mehmet Fatih Erden et al., entitled SYNCHRONIZATION FOR DATA COMMUNICATION;

U.S. patent application Ser. No. [Attorney Docket No. 108047-0116], filed on Nov. 7, 2008, by Barmeshwar Vikramaditya et al., entitled REDUCED READ/WRITE TRANSITION OVERHEAD FOR STORAGE MEDIA;

U.S. patent application Ser. No. [Attorney Docket No. 108047-0117], filed on Nov. 7, 2008, by Barmeshwar Vikramaditya et al., entitled WRITE CLOCK CONTROL SYSTEM FOR MEDIA PATTERN WRITE SYNCHRONIZATION;

U.S. patent application Ser. No. [Attorney Docket No. 108047-0118], was filed on Nov. 7, 2008, by Bruce Douglas Buch et al., entitled A WRITE COMPENSATION SYSTEM;

U.S. patent application Ser. No. [Attorney Docket No. 108047-0120], filed on Nov. 7, 2008, by Bruce Douglas Buch et al., entitled MEASUREMENT OF ROUND TRIP LATENCY IN WRITE AND READ PATHS; and

U.S. patent application Ser. No. [Attorney Docket No. 108047-0123], filed on Nov. 7, 2008, by Bruce Douglas Buch et al. for INTERSPERSED PHASE-LOCKED LOOP FIELDS FOR DATA STORAGE MEDIA SYNCHRONIZATION.

### BACKGROUND OF THE INVENTION

The invention relates generally to data storage media devices, e.g., disk drives and related technologies.

Data storage media, such as disk drives, may comprise one or more magnetic disks on which information may be stored as corresponding magnetic polarities. For example, a series of information bits, e.g., “1010” may be stored on the magnetic media as magnetic transitions corresponding to +1, −1, +1, −1. Conventionally, using what is known as “continuous magnetic media,” there is no strong requirement for the accuracy of the absolute positions of the written data positions. With continuous media, preambles, or training patterns, are written as part of the write operations, to depict the start of a data sector and the start of the data within the sector. In addition, the training patterns provide timing information for read clock synchronization, since the training patterns are written at the same time as the data using a fixed frequency write clock. As sectors are re-written, the starting points may vary slightly, and thus, read operations must re-synch at the start of each sector to ensure alignment of the read operation to the start of the data as well as the timing of the data.

With continuous magnetic media, the system reads a given sector by locating the associated training pattern and synchronizing a variable frequency read clock to the frequency and phase of the pattern as read from the medium. The synchronizing of the read clock is required to overcome differences in disk speed between the read and write operations, differences in fly height, and so forth. At the start of the sector the read clock is brought into frequency and phase synchronization with the recorded training pattern by a read channel digital phase lock loop. After the read clock is synchronized to the training pattern data, the read clock is synchronous with the data, which was recorded at the same time using the same fixed-frequency write clock.

Bit patterned media (“BPM”), on the other hand, is a relatively new technique used in magnetic data storage that provides patterns of magnetic regions (e.g., “dots” or “islands”) within non-magnetic material. In contrast to conventional continuous magnetic media, for efficient use of BPM capacity, write operations to BPM must be aligned such that write current transitions are synchronized with the patterns of dots. Synchronization is also required for reading the magnetic states of the dots.

One reason for using BPM is due to the magnetic separation (isolation) properties of the individual dots, which essentially allows reliable detection of signals recorded closer together and is beneficial to increasing information density on the media. There is always a desire to maximize storage capability on any type of storage media, and there is thus a need to efficiently utilize the increased storage capacity of BPM.

### SUMMARY OF THE INVENTION

The present invention is directed to clock synchronization techniques for data storage media, particularly for efficient use of bit patterned media (BPM) capacity. Techniques are described where an accumulated phase error between a data-rate clock and the underlying media is a fraction of a dot. Consequently, during normal operation, information exists to identify the reader and writer position within a fraction of a dot. In turn, this information can be used to obviate the requirement for the fields conventionally written preceding a data sector to provide bit synchronization and symbol framing (sector synchronization fields).

### BRIEF DESCRIPTION OF THE DRAWINGS

The invention description below refers to the accompanying drawings, of which:

FIG. 1A illustrates an example disk drive;

FIG. 1B illustrates an example block diagram of the disk drive of FIG. 1A;

FIG. 2 illustrates an example view of information stored on a media having interspersed PLL fields;

FIG. 3 illustrates an above view of the format of an example printed media to support the logical format shown in FIG. 2; and

FIG. 4 is a flowchart illustrating a procedure for eliminating sector synchronization fields.

### DETAILED DESCRIPTION OF AN ILLUSTRATIVE EMBODIMENT

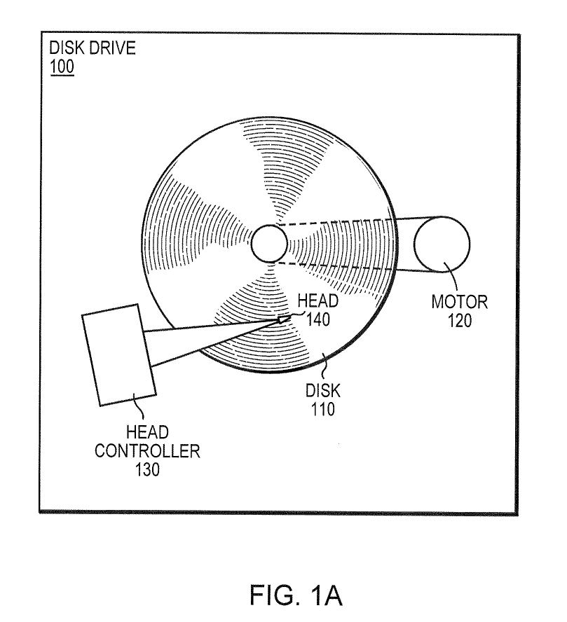

Briefly, FIG. 1A illustrates an exemplary disk drive 100 that comprises a magnetic recording medium, such as a magnetic disk 110, that advantageously may be used in accordance with the illustrative embodiments. The disk 110 may comprise, for example, a magnetic recording layer deposited on a substrate, as will be understood by those skilled in the art. The disk also may contain other magnetic or non-magnetic layers, such as a soft magnetic underlayer, exchange-coupled layer, lubrication layer, carbon overcoat, etc., which are not explicitly shown. The recording layer may be fabricated using various ferromagnetic materials and alloys, e.g., embodied as thin-film or particulate media, and may be deposited on the substrate using a variety of deposition techniques known in the art, in particular, in accordance with bit patterned media (BPM) as described herein. The substrate also may be constructed from various materials, such as glass or conventional aluminum-magnesium substrates used for magnetic disks. The disk drive 100 may also comprise a motor 120 used to spin the disk 110, as well as a head controller 130 to control a read-write head 140, as will be understood by those skilled in the art and as described herein (e.g., to control clock synchronization).

Referring now to FIG. 1B, which has elements in common with FIG. 1A, a read-write head 140 reads information from and writes information to the disk 110, which is spun by the motor 120. The head controller 130 (e.g., circuitry used to control the track, position, timing, phase, etc. of the reading and writing operations and circuitry) receives information (e.g., data or timing information) from the read-write head 140, and provides information to the read-write head, as described herein.

Illustratively, the media (e.g., disk 110) is arranged as BPM, which provides patterns of magnetic regions (e.g., “dots” or “islands”) within non-magnetic material (e.g., “troughs”). For efficient use of the BPM storage capacity, write operations to BPM should be aligned such that write current transitions are synchronized with the patterns of dots, i.e., efficient use of BPM capacity requires tight synchronization of the write clock to the phase and frequency of the media itself (i.e., to the dots). As noted above, the write operations, if not synchronized to the dots, may be attempting to write between the dots on the non-magnetic areas of the media or dots may be skipped, thereby reducing the effective storage capacity of the media.

According to above-mentioned U.S. patent application Ser. No. (Atty. Docket No. 108047-0123), techniques are provided for sampled observation of write clock timing offset relative to dot timing when writing, where the timing signals are read from respective phase-lock loop (PLL) fields. A control scheme adjusts the phase of the write clock used in the subsequent data field for writing discerned from calibrations, and, through continually-applied injections, adjusts the frequency of the write clock based on the timing offsets, which are determined using the signals previously read from the PLL fields. The write clock timing then coasts in between PLL fields, while a write operation continues with a write clock having updated phase and frequency. When the reader arrives at a next PLL field, data writing is suspended while timing information is extracted from the PLL field.

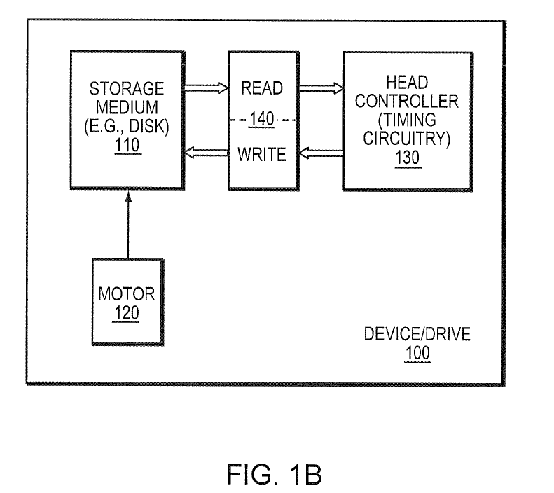

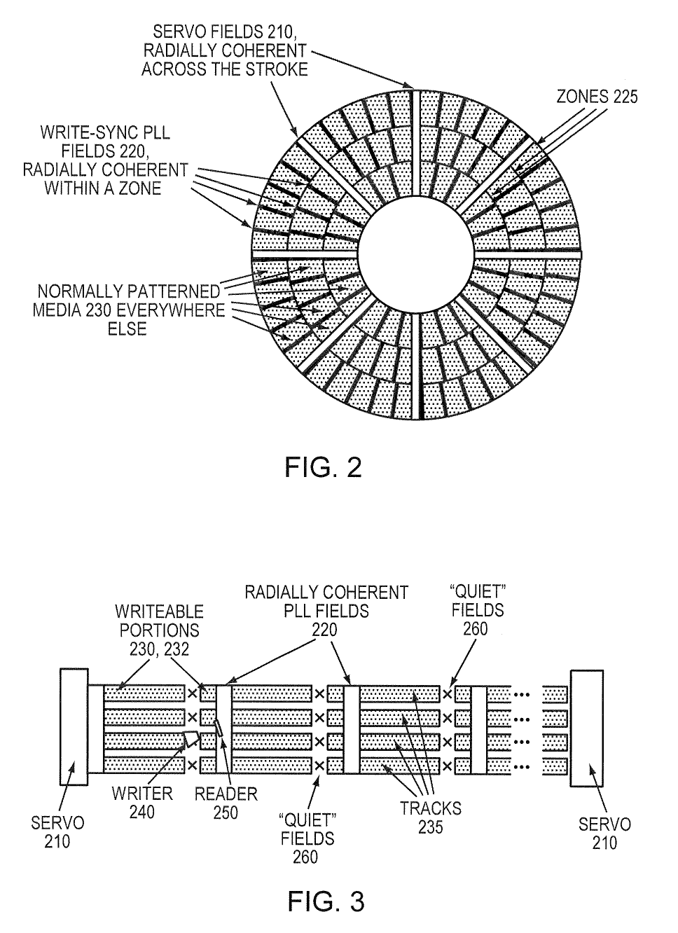

FIG. 2 illustrates the format of BPM (e.g., disk 110) to support the logical format shown in FIG. 3. For sake of context, FIG. 2 shows various servo fields/areas 210 and PLL fields 220, but makes no assumptions about servo field position relative to the PLL fields. It is assumed, for now, that the PLL fields 220 occur more frequently than the servo fields.

The servo fields 210 are radially coherent across the disk surface. In the example, the PLL fields 220 are radially coherent within a “zone” 225. Within a zone, the same number of dots occur between PLL fields, and thus, the radially coherent PLL fields are read at regular dot intervals (where being radially coherent within a zone implies that the same signal may be read from a read head position anywhere across the zone). Since the PLL fields provide a timing reference for the zone, this per-zone radial coherence is consistent with the patterning of data dots for constant-density recording per-zone. In other words, each data portion 230 between a pair of PLL fields 220 within a zone illustratively comprises the same number of dots, spaced at a same linear frequency according to the radial position of the zone on the underlying disk surface. Illustratively, the dot pattern of the PLL fields 220 provide readback of a signal that is recorded with a predetermined number of dots per cycle (e.g., 1, 1, −1, −1, etc.).

The data are written to and read from the regions 230 between the interspersed PLL fields. While making these PLL fields aligned to logical block boundaries would simplify format control, such alignment is not necessary. Rather, in the example, the data areas are interrupted with the permanently written (e.g., “read-only”), radially coherent PLL fields 220. The “X's” illustrate unused areas in the format that roughly match the length of the interspersed PLL fields. These “quiet” fields 260 correspond to the position of the writer 240 when the reader 250 is over the radially coherent PLL fields 220. Where the distance between the writer and reader is greater than the PLL field, a “runt” data field 232 results after a quiet field 260, where additional data may be written.

FIG. 3 illustrates an example view of information stored on a BPM having interspersed PLL fields. In particular, between conventional servo fields 210, one or more PLL fields 220 may be interspersed at predefined intervals within writeable fields 230 of tracks 235 (e.g., four shown). A read-write head 140 is illustrated, with a writer 240 and a reader 250 that are separated by a known distance. Notably, an illustrative PLL field comprises a known pattern that produces a periodic read-back waveform with a known period of four dots, e.g., ++−− (“bipolar”) or ++00 (“unipolar”), referred to as a 4 T-per-cycle dot pattern.

Illustrative techniques that may be used to maintain timing synchronization is described in more detail in above-referenced U.S. patent application Ser. No. (Atty. Docket No. 108047-0123), which describes how phase and frequency errors are determined from reading signals from interspersed PLL fields. The phase and frequency errors are used to drive the write clock frequency to the precise phase and frequency of the media dots, as described in more detail in above-referenced U.S. patent application Ser. No. (Atty. Docket No. 108047-0117). The write clock update resulting from the reading of an interspersed PLL persists until a next PLL field, where another phase and also frequency update occurs. During the PLL-to-PLL interval, phase error accumulates, due to, for example, mechanical disturbances. However, as noted, the interval between PLL fields is specifically chosen to ensure that under worst case expected conditions, the accumulated phase error stays within an acceptable range. In addition, according to above-mentioned U.S. patent application Ser. No. (Atty. Docket No. 108047-0115), this accuracy may be maintained through various techniques designed for BPM devices. For instance, a phase error may be determined from a single PLL field and a frequency error may be determined from the phase errors associated with successive PLL fields.

Currently, as noted above, when data are written, a preamble is conventionally written with a training pattern to allow a read clock to synchronize to the phase and frequency to lock to the written data, and a subsequent synchronization field is included to indicate the start of the actual data. In particular, these fields are often referred to as the sector preamble and the “data sync” or “address mark” fields. Although the phase and frequency of the preamble is coherent with the data that follows, it contains no means to discern where preamble ends and data begins. Hence, a data sync character (e.g., generally a pattern of two or three dozen bits), identifying the specific bit location that starts the following data fragment, is written following the preamble. This sync character may be detected by a sync detector (not shown) during reading.

According to the present invention, the frequency and phase lock established by the interspersed PLL fields used for write synchronization may be utilized to dictate write locations to the accuracy of an individual dot. Correspondingly, this also allows for maintaining the state of the reader position to the accuracy of an individual dot. The combination of these two factors, along with maintaining the location of the start of written data down to the dot level, eliminates the need for the preamble and sync fields that are conventionally used to establish bit synchronization and symbol framing.

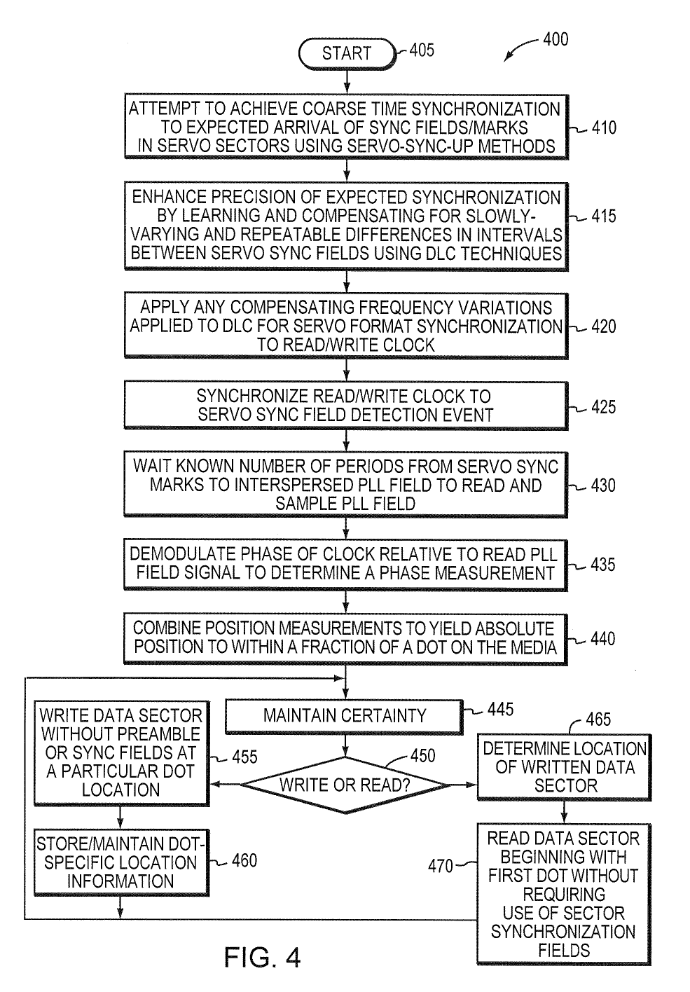

FIG. 4 illustrates an example procedure 400 demonstrating how a drive's controller may start up with no position context and arrive at a known position with single-dot precision using the servo and PLL fields. Specifically, a disk drive 100 may start up in step 405, and in step 410 may attempt to achieve a coarse time synchronization to the expected arrival of sync fields (or marks) in the servo sectors 210 using servo-sync-up methods known to those skilled in the art. That is, based on detection of the sync fields, the disk drive can reasonably determine the frequency at which sync fields occur on the disk. Further, in step 415 the precision of the expected synchronization is enhanced by learning and compensating for slowly-varying and repeatable differences in the intervals between the servo sync fields using known Disk Locked Clock (DLC) techniques. In this manner, a clock is synchronized to the rotational speed of the spinning disk, and in step 420, any compensating frequency variations applied to the clock during servo format synchronization may be applied to a data-rate clock (e.g., a read or write clock).

According to the present invention, the data-rate clock may then be synchronized to the servo sync field (mark) detection events in step 425, e.g., utilizing conventional techniques. Note that, due to means used to avoid meta-stability when an event generated in one clock system is synchronized to an independent clock domain, the synchronization results in an uncertainty of one data clock period in the location of the servo sync marks relative to other events in the data clock domain. In other words, typical sync field synchronization results in a slight ambiguity of the exact timing location within a sync field. With conventional continuous write media, this ambiguity is acceptable. However, for use with BPM according to the present invention, further accuracy may be achieved in steps 430-440. In particular, since the number of data clock cycles (and number of media dots) between the servo sync field and the first interspersed (pre-written) PLL field 220 is known, in step 430 the system may wait this number of cycles from the detection of servo sync marks, and may read and sample the interspersed PLL field based on the data-rate clock. Then, in step 435 the phase of the clock relative to the signal read from the PLL field may be demodulated, to determine a phase difference (offset) between the clock and the media dot pattern.

The phase measurement may be used to identify position within a PLL field over an unambiguous range. For instance, for an illustrative 4 T-per-cycle PLL pattern (as mentioned briefly above), this range is ±2 dots, since position within a cycle may be determined with a certainty from the 4 T-per-cycle pattern after reading at least one cycle of four dots.

Since servo sync detection identifies position with an uncertainty of one dot (one clock period), these two position measurements may be combined in step 440 to yield absolute position to within a fraction of a dot on the media. Specifically, by combining the one dot/clock period uncertainty with the particular data pattern of the PLL fields, synchronization of the clock to within a fraction of a dot may be determined, thus removing any uncertainty. As such, in step 445, so long as this certainty is maintained, such as, for example, where the interspersed PLL fields 220 have an interval based on a maximum allowable timing “drift” between re-synchronization of the clock, synchronization to within a dot may be maintained (i.e., by re-synchronizing the read or write clock using each interspersed PLL field). Note that, error in excess of a per-dot specificity (that is, an offset beyond a particular timing error threshold, e.g., by half a dot) suspends writing until the synchronization error is reduced.

According to the present invention, therefore, by applying knowledge of the BPM format and using the techniques above to obtain dot specificity, a write operation and a read operation are able to determine exactly which dot is being written or read. This enhanced state of both knowing at which dot the data write started as well as having a data-rate clock synchronized to the media pattern on which the data are written via the PLL fields advantageously allows for the elimination of conventional sector synchronization fields, i.e., preambles and sync fields typically included within a data sector. In other words, because the timing is kept synchronized with the media to within a fraction of a dot, and because the dot location of the start of the data writing is known, precise dot addressing may be used for writing and reading data sectors from a BPM formatted disk.

Because per-dot precision may be determined and maintained, according to the invention either a write or read operation is performed (step 450) using this precision without a need for sector synchronization fields. For instance, where write operations are performed in step 455, a data sector may be written without preamble or sync fields at a particular dot location (e.g., track X, dot Y), and the dot-specific location information may be stored/maintained in step 460 (e.g., by disk controllers). Conversely, when reading back a particular data sector, the location of the written data sector may be determined in step 465 (e.g., track X, dot Y), and the reader may begin reading the data sector in step 470 beginning with the first dot (Y) without requiring use of the sector synchronization fields (preamble or sync fields). Note that during writing or reading, the procedure may return to step 445 to maintain the per-dot precision based on the interspersed PLL fields. A “state” of the read-write head may thus be maintained through consistent knowledge of read-write head location, e.g., based on a number of clock cycles (or dots) since a previously known location (e.g., a servo sector sync field, a previous PLL field, etc.), such that per-dot (or “dot-based”) addressing read and/or write operations may be performed.

Advantageously, the novel invention thus eliminates sector synchronization fields when writing data on BPM. In particular, by using interspersed PLL fields in a manner as described above, tightly accurate clock synchronization may be maintained. As such, the accumulated phase error is a fraction of a dot, and state information may be used to correspondingly identify the reader and writer position within a fraction of a dot. Accordingly, the novel invention utilizes this state information to obviate the requirement for the fields conventionally written preceding sector fragment data to provide bit synchronization and symbol framing. Moreover, these conventional preambles and data sync fields comprise overhead amounting to roughly 4% of a data sector. Eliminating the need for these overhead fields helps to offset the overhead added by the interspersed PLL fields required to maintain write clock synchronization to the media dot patterns, which results in an overall increase in the effective storage capacity of BPM.

While there has been shown and described an illustrative embodiment that eliminates sector synchronization fields when writing data on BPM, it is to be understood that various other adaptations and modifications may be made within the spirit and scope of the present invention. For example, the invention has been shown and described herein for use with particular forms of magnetic media. However, the invention in its broader sense is not so limited, and may, in fact, be used with other suitable data storage forms (e.g., with conventional magnetic media). Also, while the invention has been shown using various distances, tolerances, layouts, etc., other values/layouts may be used in accordance the present invention where applicable.

The foregoing description has been directed to specific embodiments of this invention. It will be apparent, however, that other variations and modifications may be made to the described embodiments, with the attainment of some or all of their advantages. Accordingly this description is to be taken only by way of example and not to otherwise limit the scope of the invention. Therefore, it is the object of the appended claims to cover all such variations and modifications as come within the true spirit and scope of the invention.

What is claimed is:

1. A method for dot-based addressing for operations on a data storage medium, the method comprising:
acquiring and maintaining dot-specific position and timing information for a data-rate clock; and
reading a data sector beginning from a specific dot without reading sector synchronization fields.

2. The method as in claim 1, further comprising:
writing a data sector beginning at a specific dot without writing sector synchronization fields.

3. The method as in claim 1, wherein acquiring further comprises:
determining dot positioning and timing information from a servo synchronization field to within an uncertainty of one dot; and
applying the one dot uncertainty to a known pattern of a phase-locked loop (PLL) field to determine dot-specific position and timing information.

4. The method as in claim 3, wherein the known pattern is a 4 T-per-cycle pattern.

5. The method as in claim 3, further comprising:
determining dot-specific position and timing information based on a known number of data clock periods between the servo synchronization field and the PLL field.

6. The method as in claim 1, wherein maintaining further comprises:
updating dot-specific position and timing information based on a plurality of interspersed phase-locked loop (PLL) fields.

7. The method as in claim 6, wherein the plurality of interspersed PLL fields occur at an interval based on a maximum allowable drift between updating of timing information to remain dot-specific.

8. The method as in claim 1, wherein a sector synchronization field comprises a training pattern preamble and a sync character.

9. The method as in claim 1, wherein the data storage medium is a magnetic data storage medium.

10. The method as in claim 1, wherein the data storage medium is a bit patterned magnetic data storage medium.

11. An apparatus for dot-based addressing for operations on a data storage medium, the apparatus comprising:
a read-write head;
timing circuitry configured to acquire and maintain dot-specific position and timing information for a data-rate clock associated with the read-write head; and
a head controller configured to direct the read-write head to direct the read-write head to read a data sector beginning from a specific dot without reading a sector synchronization field.

12. The apparatus as in claim 11, wherein the head controller is further configured to:
direct the read-write head to write a data sector beginning at a specific dot without writing a sector synchronization field.

13. The apparatus as in claim 11, wherein the timing circuitry is further configured to:
determine dot positioning and timing information from a servo synchronization field to within an uncertainty of one dot; and
apply the one dot uncertainty to a known pattern of a phase-locked loop (PLL) field to determine dot-specific position and timing information.

14. The apparatus as in claim 13, wherein the known pattern is a 4 T-per-cycle pattern.

15. The apparatus as in claim 13, wherein the timing circuitry is further configured to determine dot-specific position and timing information based on a known number of data clock periods between the servo synchronization field and the PLL field.

16. The apparatus as in claim 11, wherein the timing circuitry is further configured to update dot-specific position and timing information based on a plurality of interspersed phase-locked loop (PLL) fields.

17. The apparatus as in claim 16, wherein the plurality of interspersed PLL fields occur at an interval based on a maximum allowable drift between updating of timing information to remain dot-specific.

18. The apparatus as in claim 11, wherein a sector synchronization field comprises a training pattern preamble and a sync character.

19. The apparatus as in claim 11, wherein the data storage medium is a magnetic data storage medium.

20. The apparatus as in claim 11, wherein the data storage medium is a bit patterned magnetic data storage medium.
